(19) United States
(12) Patent Application Publication
(10) Pub. No.: US 2001/0027459 A1
(43) Pub. Date: Oct. 4, 2001

(54) Method and apparatus for electronic document exchange

(76) Inventor: Gregory T. Royal, Plano, TX (US)

Correspondence Address: David L. McCombs, Haynes and Boone, LLP, Suite 3100, 901 Main Street, Dallas, TX, 75202, US

(21) Appl. No.: 09/795,790

(22) Filed: Feb. 28, 2001

Related U.S. Application Data
(60) Provisional application No. 60/169,213, filed on Dec. 3, 1999.
(60) Provisional application No. 60/186,014, filed on Mar. 1, 2000.

(51) Int. Cl. G06F 15/00

(52) U.S. Cl. 707/513; 707/530

(57) ABSTRACT

A method and apparatus for performing electronic document exchange between a plurality of parties is described. Each party may have a multiple number of data communications processors at various locations. These data communications processors or servers transmit documents between respective parties under the context of relationships between the two or more parties. When the organizations decide on those relationships, they exchange capability to exchange documents through the establishment of a security protocol model and document type definitions (DTD) for the exchanged documents. These DTDs are stored within relationship containers on the server. The relationships are stored within organizational containers. Additionally, DTDs inherit attributes of the relationship and of the organization. Multiple documents in relationships and multiple relationships within organizational containers can exist. The logic of the document is defined within the context of the relationship between two parties. This logic is associated with the DTD and stored within the appropriate relationship where the DTD is stored. Once a document is received, the DTD is extracted and the relationship is located for that DTD. At each step, the requestor is tested to see whether the request is working within the relationship security model and the bounds of that relationship. The document and the decision template are passed through the engine and the result set is marked up and passed back to the requester.

### CROSS REFERENCE TO RELATED APPLICATIONS

This patent is cross-reference to patent application “Method and apparatus for using an expert system to execute business documents to facilitate electronic commerce” filed on Dec. 3, 1999 and Ser. No. 60/169213. This invention claims the benefit of U.S. Provisional patent application Ser. No. 60/186,014 filed on Mar. 1, 2000.

### FIELD OF THE INVENTION

The invention relates generally to computers and, more particularly, to a method and apparatus to facilitate the exchange of electronic documents between businesses and other types of organizations, and the subsequent processing of such documents.

### BACKGROUND OF THE INVENTION

An electronic commerce network enables corporations to transact business over the Internet or other Networks. A characteristic of this environment is that each party employs one or more systems, services and protocols to support processes within their organization. Another characteristic is that documents and document structures differ according to the context of the prevailing relationship between two or more parties using the document. For example, an order document is regarded and processed differently when viewed from a manufacturing context than from an accounts receivable or an employee commission context.

The major area of prior art associated with the transmission of documents is in the Electronic Data Interchange (EDI) area. For example, U.S. Pat. No. 5,894,558 (Falker) teaches converting a document by means of a normalization process into standard formats for both structure and meaning. Although structure normalization is necessary to traverse standard network protocols, standardizing the document's meaning requires a data dictionary, an identification and use description for each field contained within the document, for each party. This method does not provide flexibility for users of the system. Modification of the data dictionary is slow and cumbersome, and required all parties to have identical versions installed at all times. Furthermore the logic of routing of documents is fixed and limited by the rule sets supported by the data dictionary used.

U.S. Pat. No. 4,648,061 (Foster) teaches a distribution network for the interchange of documents by creating an underlying protocol that negotiates between two or more processors and interrogates the respective capabilities to transmit documents. There still must be a structure and meaning predefined to the document once the negotiation is complete.

U.S. Pat. No. 5,878,398 (Tokuda et al) teaches the routing of documents between document type and the associated users or departments of that document. This routing method is simplistic and does not take into account different types of recipients and their respective needs in the context of the document. For example, an Order Form coming from an external party may need to be handled by several parties simultaneously. The sales department, the purchasing department and the accounts department may need knowledge of the document. This invention only provides for serial routing of documents, and not multiple parallel paths for the document.

U.S. Pat. No. 5,557,70 (Edwards et al) teaches document structure for meaning within the Electronic Data Interchange (EDI) format. With EDI the data dictionary is previously defined and uses a simple translation technique to move between standardized EDI documents and internal data formats. This does not allow a document to be routed within the context of the relationship with the third party and does not allow the flexibility of definingmeaning and logic for documents.

U.S. Pat. No. 5,983,248 (DeRose et al) teaches the means for indexing, navigating, and displaying electronic documents on an output device. The descriptive markup describes the content and the meaning of “tagged” data within the document. However, it does not provide for the logical use of that document. For example, although it may describe the fact that it is a purchase order, and that a purchase order has various fields of data, and that data can be represented by a tree, and that tree is displayable, it does not provide for the logic of what to do with that document. Once the document is rendered for display or print, it is up to the user to decide how to process it.

Therefore, what is needed is an invention that facilitates electronic document exchanges utilizing standard protocols and that is flexible to use.

### SUMMARY OF THE INVENTION

The present invention provides a system and method for electronic exchange and processing of documents, using standard protocols, via private and public communications networks. Each participating organization defines a relationship to other organizations, including security rules (model), definitions for documents exchanged with other organizations, and rules (decision templates) for processing each document type. As documents are exchanged between organizations, the security model, the document definitions and associated decision templates manage and control the flow and processing of exchanged documents.

Accordingly, besides the several objects and advantages of the invention described above, several objects and advantages of the present invention are now described. First, the system and method facilitate commercial transactions over a computer driven network capable of providing communications between at least two parties.

Another object is to provide an electronic computer architecture that accommodates a wide variety of commerce transactions including those that are now currently physical in nature.

Another object is to provide a means for transmitting and receiving XML documents over a public or private infrastructure reliably and securely.

Another object is to provide a means to associate logic to data documents within the context of relationships between two or more parties.

It is a further objective to identify documents that are to be transacted with the context of relationships between two or more parties.

It is a further objective to identify document types and assign decision trees to those document types to facilitate transactions.

It is a further object to provide an abstract layer above existing applications to facilitate electronic document exchange.

It is a further object of the invention to provide a mechanism for the unfettered establishment of electronic commerce relationships without due regard for technologies or systems.

Therefore, in accordance with the previous description, objects, features and advantages of the present invention will become apparent to one skilled in the art from the subsequent description and the appended claims taken in conjunction with the accompanying drawings.

### BRIEF DESCRIPTION OF THE DRAWINGS

FIG. 1 is a diagram of the environment and major components of electronic document exchange;

FIG. 2 is a diagram of the organizational container, the relationship container and the document definitions and decision templates;

FIG. 3 is a flow diagram on the creation of organizational containers;

FIG. 4 is a flow diagram on the creation of the relationship container;

FIG. 5 is a flow diagram on adding document adding decision trees to document definitions within a relationship container; and

FIG. 6 is a flow diagram of how an incoming document is handled.

### DETAILED DESCRIPTION OF THE INVENTION

The foregoing and other objects, advantages and manner of operation and novel features will be understood from the detailed description when read in conjunction with the accompanying drawings.

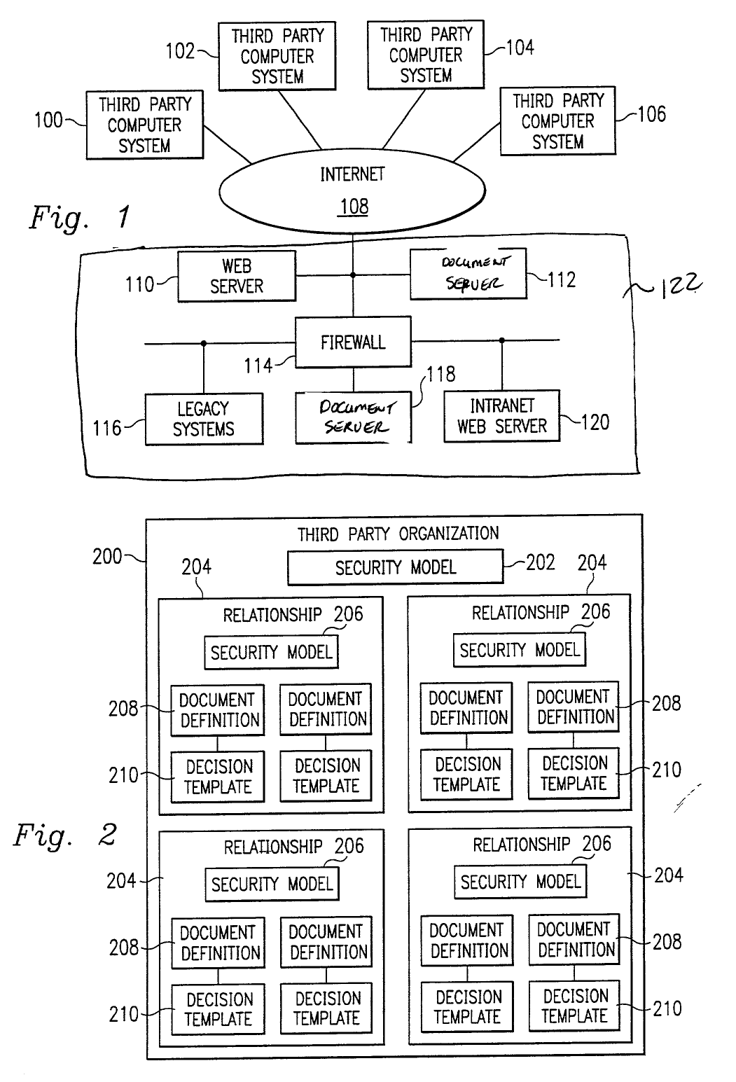

Refer to FIG. 1. Two or more computer systems, shown as “Third Party Computer System” 100-106, are connected to the Internet via communications lines. (It should be clear, that these could also be entities, e.g. departments, branches, headquarters, etc., within the same company. It should also be clear that the Internet could also be an intranet, or a LAN or WAN communication network for example.) Each system is similarly configured, 122, with web servers 110, document servers 112, security monitors, e.g. “firewalls” 114, production systems 116, location/department, etc. document servers, and intranet web servers 120. (Not all components may be in all systems.)

Within this network, access to specific information is through a standard address called the “Universal Reference Locator” or URL. The URL allows one computer within the Internet to request and receive a specific file from another computer connected to the Internet. These individual files may be public or protected by userid/password combinations. Within the current invention, this technique is used for one customer system to access document and document information within another computer, including document interchange.

Refer to FIG. 2. Each participating organization defines an “organizational container” 204 for each other participating organization. If there are N participating organizations, each organization will have N-1 containers, one for each of the others.

An organizational container consists of a security model 206 which gives the rules for document exchange to that organization. These rules may include rules such as “free exchange of all documents”, “classified documents may not be sent or received”, “order documents only”, or “documents may be received and not sent”.

The container has one document definition (Document Type Definition or “DTD”) 208 for each document type exchanged with the organization. This document type definition defines what data elements can and must be included in the document. Associated with each DTD 208 is a decision template 210. The decision template 210 contains the logic of how the document is to be handled once received.

The invention takes place in two phases: the definition of organizations and organizational containers; and the interchange of documents between organizations once defined.

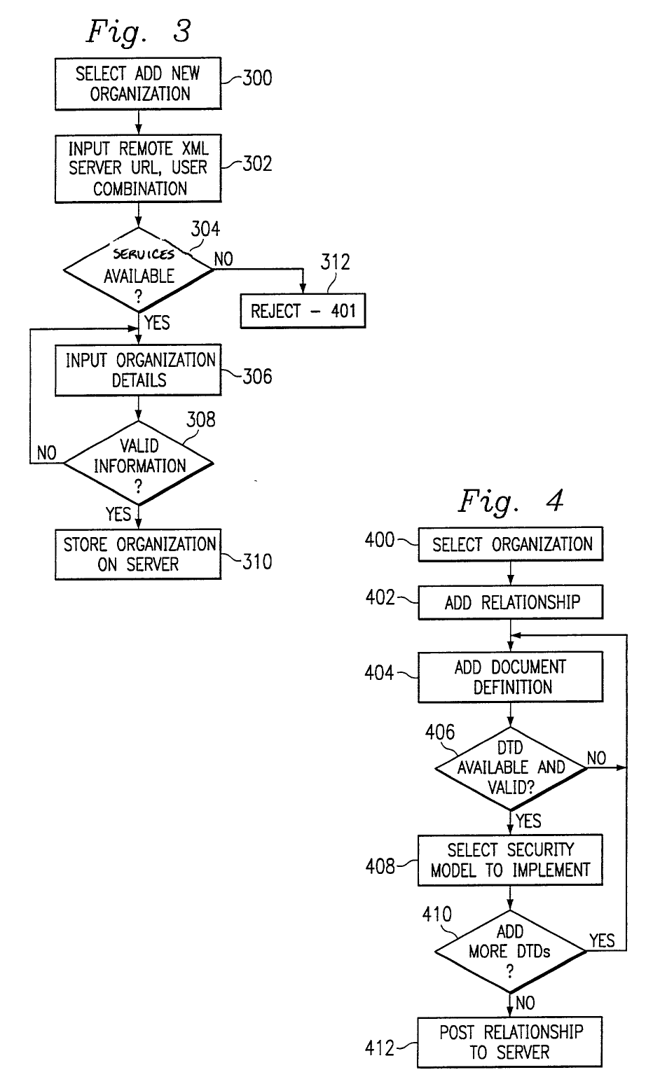

The first phase is shown in FIGS. 3-5. FIG. 3 shows how the third party organization container is created. The user firstly adds a new organization 300. The user then enters the default URL and user password combination 302. If the URL and user password combination is not accepted 304 then it is rejected 312. If it is accepted then the details are either retrieved from the remote server or inputted by the user 306. The information is then tested for validity 308. If the information is incorrect, then the details are requested from the user. If the information is correct, the organization container is stored on the server 310. At the completion of this step, the URL of the document server on the remote organization's document server is stored on each other computer which has a relation with the organization.

Refer now to FIG. 4. This shows how relationships are created inside organization containers. First, the organization container previously created is selected 400. Then the new relationship is added 402. Within this relationship, document definitions (DTD) URLs are added 404. The URL is then tested to see if the DTD is available and valid 406. If valid then the security model is requested. This can be the default or a alternate model inputted 408 by the user. If there are more DTD's to add then these are added as well. The relationship is then stored on the server. At the end of this step, each relationship between the organizations is defined, including security rules used between the organizations.

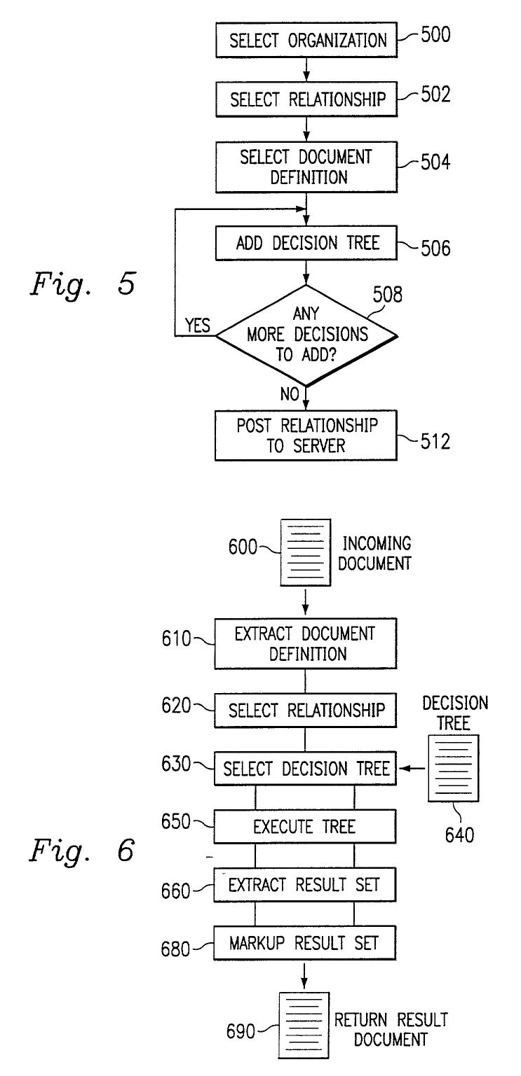

Refer to FIG. 5. This shows the addition of a decision tree to a document definition. First, the user selects the organization container 500, then selects the relationship within the organization 502. Then the user selects the document definition previously added to the relationship container 504. A decision tree is then added to the document definition 506. This can be created or a previously created definition may be used. If there are more definitions, then they are also added 508. The relationship is then saved on the server.

Thus at the completion of phase one, each of the organizations are defined and each of the relationships between organizations are defined. The relationship defines the security rules between organizational pairs, documents exchanged between the organizations, and the decision tree used to process each document received. This information is stored on servers within the Internet as documents, identified by a URL and possibly protected by userid/password.

Phase two consists of the interchange of documents between the organizations set up in phase 1. Refer now to FIG. 6. It shows the path an incoming document 600 takes. The document is received and the document definition type is extracted from the document 610. The sending organization is identified from information in the DTD. The predefined relationship with that organization is then found 620. From that relationship 630, the decision tree is extracted 640. The tree is then executed 650. The result set is the extracted from the server 660. The result set is marked up 680 and the output document 690 is dispatched.

In sum, a number of advantages of the invention become evident. First, the present invention provides the ability to tailor business rules and logic depending on the context of the document within the relationship with a third party. This allows for many different documents to be handled with out the need for coding each document instance.

In addition, the preferred embodiment provides the ability to transact business between a multiplicity of partners within the instance of a transaction, have a multiplicity of relationships within the instance of a transaction, and have a multiplicity of decisions within the instance of a transaction.

Moreover, the ability to provide extensible business logic through compound templates will allow businesses to greatly improve the automation of business transactions and reduce the cost of those transactions.

Furthermore, the present invention provides a method and apparatus for the movement of any types of business to business or business to consumer document or group of documents to assist in transactions or information dissemination.

While the above description contains may specifics, these should not be construed as limitations to the scope of the invention, but rather as an exemplification of one of the preferred embodiment thereof. Many other variations are possible. For example Electronic Document Exchange could be used as a means to facilitate the exchange and conversion of a document from one definition to another. It can be used to serve clients as well as other servers or any remote application that wishes to move electronic documents.

Additionally, Electronic Document Exchange lends itself to: a) conversion of documents between definitions; b) It lends itself to business document aggregation wherein multiple documents form the instance of the relationship between a multiplicity of parties; c) It lends itself for multiple documents within a single transaction or common transactions; and d) it lends itself to handle multiple language documents. Accordingly, the scope of the invention should be determined not by the embodiments illustrated, but by the appended claims and their legal equivalents.

1. A method for the electronic document exchange of XML documents consisting of a multiplicity of communicating data processors, the method comprising:
creating an organizational container for each of a plurality of parties;
creating a plurality of relationship containers for each relationship between two or more of the plurality of parties;
installing the plurality of relationship containers inside the appropriate organizational container;
identifying an appropriate document to formalize each relationship between two more of the plurality of parties;
exchanging the Uniform Resources Locator (URL) of a Document Type Definition (DTD) of the appropriate document;
assigning a decision tree for each DTD; and
storing the DTD and the decision tree in the appropriate relationship container.

2. The method according to claim 1, further including:
determining a method of transacting documents;
establishing a document interchange session based upon the result of the determining step;
transmitting a document from a first party to a second party according to the appropriate relationship;
receiving the electronic document by the second party from the first party;
extracting the DTD from the document; and
retrieving the decision tree for that Document Type Definition.

3. The method of claim 2, further including executing the document as per the decision tree and extracting a plurality of results.

4. The method of claim 3, further including passing the plurality of results back to the second party.
